(19) United States
(12) Patent Application Publication
(10) Pub. No.: US 2015/0231767 A1
(43) Pub. Date: Aug. 20, 2015

(54) FASTENING DEVICE AND METHOD

(71) Applicant: Airbus Operations GmbH, Hamburg (DE)

(72) Inventors: Rüdiger Botha, Hamburg (DE); Hamid Ebrahimi, Scharnebeck (DE)

(73) Assignee: Airbus Operations GmbH, Hamburg (DE)

(21) Appl. No.: 14/624,626

(22) Filed: Feb. 18, 2015

(30) Foreign Application Priority Data
Feb. 19, 2014 (DE) 10 2014 102 106.1

(51) Int. Cl. B25B 3/00

(52) U.S. Cl. CPC B25B 3/00

(57) ABSTRACT

A fastening device includes a fastening needle system, which is guided in a base body of the fastening device. The fastening needle system is configured to be led through a drilling hole of one or more components. By exercising a pulling force onto the fastening needle system, the components can be fastened between the front portion of the fastening needle and the base body. A fastening system may include the fastening device and a fastening pliers.

### FIELD OF THE INVENTION

The present invention relates to the temporary clamping of components. In particular, the present invention relates to a fastening device, to a fastening system, and to a method for clamping two components to be connected.

### BACKGROUND OF THE INVENTION

To connect components temporarily before they are definitively fixed to other components, what are known as fastening screws can be used. These conventionally comprise a base body and a fastening needle, it being possible for the components to be gripped to be clamped between a fastening needle head of the fastening needle and the base body. For this purpose, the fastening needle can conventionally be guided through a hole in the components, in such a way that the components can subsequently be clamped between the fastening needle head and the base body.

To achieve clamping, the fastening needle or fastening needle head can be retracted by means of a threaded rod, the fastening needle head spreading out during the retraction of the fastening needle in such a way that the fastening needle head catches on the hole of the components and the components can be clamped.

In this context, the threaded rod can be tightened by way of a screw thread. This tightening of the threaded rod by means of a screw movement may be relatively time-consuming, require special tools and not least there may also be the risk of there being an excessive clamping force on the components as a result of an excessive torque being exerted on the threaded rod, and this in turn may potentially damage the components.

### BRIEF SUMMARY OF THE INVENTION

A first aspect of the present invention relates to a fastening device for temporarily clamping a component, the fastening device containing a fastening needle system, comprising a fastening needle and a fastening needle head, and a base body, comprising an internal space for the guidance of the fastening needle system. The fastening needle system is displaceable relative to the base body in the internal space of the base body by applying a tensile force to the fastening needle system in the direction of a longitudinal axis of the fastening needle system. The fastening device is further configured to clamp the component between the fastening needle head and the base body.

In other words, the fastening device may be understood to be a device for temporarily connecting components which contains a fastening needle system which is guided through the base body of the fastening device. The fastening needle system can be guided through a hole in one or more components. By exerting a tensile force on the fastening needle system, the component or components can be clamped between the fastening needle head and base body of the fastening device.

The device may also be configured for temporarily clamping a plurality of components.

The fastening needle system may comprise a plurality of elements which can be interconnected. The fastening needle may be configured to be guided through a hole in the component. For example, the fastening needle system may comprise a fastening needle and a fastening needle shaft which are interconnected. The fastening needle of the fastening needle system may be formed in a single piece and/or may be made of a forged material. The fastening needle head may refer to a region of the fastening needle which can be spread radially with respect to the longitudinal direction of the fastening needle. In other words, the diameter of the fastening needle head may be variable. The fastening needle may be machined in such a way that at least the fastening needle head is flexible. This means that the spreading of the fastening needle head can be reversible, in such a way that the diameter of the fastening needle head is reduced again when the fastening needle is released. In this way, the fastening needle can be removed from the hole in the components. For example, the fastening needle head may be located on one end of the fastening needle, preferably on the end remote from the base body of the fastening device.

The fastening needle may for example be of a length of 114 mm to 130 mm and have a diameter of 4 mm. Further, the length of the fastening needle may be dependent on the stack thickness of the components to be fastened, it being possible for the stack thickness to be for example between 4 mm and 20 mm. The fastening needle head diameter may for example be 15 mm and the housing diameter may for example be 18 mm. The maximum spring path of the resilient force transmission element or plate spring package may be 2 mm.

The base body may be understood to be a component or element of the fastening device which is configured to receive and/or to guide the fastening needle system. For example, the base body may be turned or milled from metal. The internal space of the base body may comprise one or more holes. The internal space of the base body may further comprise recesses which have a non-round cross section. For example, the internal space or part of the internal space may be in the form of a slot. The cross section of the internal space of the base body may for example be adapted to the fastening needle system in such a way that merely a translational movement of the fastening needle system relative to the base body in one direction is possible. Further, the internal space of the base body may also be configured in such a way that a rotation of the fastening needle system about a longitudinal axis of the fastening needle system in the internal space of the base body is possible.

The fastening needle system may have a longitudinal axis which is parallel to the longitudinal axis of the fastening needle. By applying a tensile force or a compressive force to the fastening needle system, the fastening needle system may be movable relative to the base body in the internal space of the base body. This means that a screw movement of the fastening needle system relative to the base body is not required so as to bring about the movement of the fastening needle system relative to the base body in the direction of the longitudinal axis of the fastening needle system.

The fastening needle system may also be lockable to the base body or arrestable in the internal space of the base body. This means that the position of the fastening needle system can be fixed relative to the base body. This arresting of the fastening needle system in the base body may for example be provided by way of arresting or locking in a friction fit between the fastening needle system and the internal space of the base body. This arresting may also be reversed again so as to release the fastening device from the component or components again.

The fastening device may be used in the structural assembly of a fuselage in aircraft construction or ship construction. For example, the fastening device may be used when closing longitudinal and transverse seams. Further, the fastening device may be used in various fields of prefabricated construction where it is necessary to hold a plurality of parts together temporarily.

The fastening device according to the invention has the advantage that it can be assembled and clamped in a simple manner from one side of the component. A screw movement of the fastening needle system is not required for clamping the fastening device, meaning that the fastening device can be clamped using a simple movement. Moreover, no expensive and/or heavy tools have to be provided for clamping the fastening device.

According to one embodiment of the invention, the fastening needle system can be arrested in the internal space of the base body by rotating the fastening needle system about the longitudinal axis of the fastening needle system.

In other words, the fastening needle system can be arrested in the internal space of the base body by rotating the fastening needle system relative to the internal space of the base body. The rotation of the fastening needle system about the longitudinal axis of the fastening needle system may for example take place continuously until the build-up of force for arresting is complete. For example, the angle of rotation of the fastening needle system may at most be 45°. The angle of rotation may further be dependent on the cam configuration. Preferably, the clamping may be achieved by way of a rotation through 10° to 15°.

In this way, the fastening needle system can be arrested in the internal space of the base body with a simple movement.

According to a further embodiment of the invention, the fastening needle system comprises a cam for arresting the fastening needle system in the internal space of the base body.

A cam may be understood to be a region of the fastening needle system and/or of the fastening needle shaft which is arranged eccentrically with respect to the longitudinal axis of the fastening needle system. As a result of the fastening needle system rotating about the longitudinal axis of the fastening needle system, the eccentrically arranged region or the cam can be brought into mechanical contact with the base body, in such a way that the eccentrically arranged region or the cam can be arrested or locked in the base body in a friction fit. In other words, the cam can be rotated from an arrested configuration to a non-arrested configuration of the fastening needle system. The cam of the fastening device may for example be configured in such a way that the base body comprises a slot and the fastening needle system in the internal space of the base body has an oval cross section in the region of the slot. By rotating the fastening needle system, the slot and the region of the fastening needle system having the oval cross section can be arrested in a friction fit.

In this way, a mechanically simple solution for arresting the fastening needle system in the internal space of the base body can be provided, which comprises few movable parts and is therefore less susceptible to faults. Moreover, by way of the cam a high arresting force for the fastening needle system can be provided.

According to a further embodiment of the invention, the fastening needle system comprises a fastening needle shaft which is connected to the fastening needle in such a way that the fastening needle shaft is rotatable about the longitudinal axis of the fastening needle system with respect to the fastening needle when the fastening needle system is arrested.

In other words, the fastening needle shaft may be rotatable relative to the fastening needle about the longitudinal axis of the fastening needle system. Further, the fastening needle shaft may be connected to the fastening needle in such a way that a relative movement of the fastening needle shaft along the longitudinal axis of the fastening needle system with respect to the fastening needle is not possible. This means that merely a rotational movement of the fastening needle shaft with respect to the fastening needle may be possible.

In this way, the fastening needle need not rotate together with the fastening needle shaft when the fastening needle system is arrested by rotating the fastening needle shaft. This may for example be advantageous if the fastening device further comprises a fastening needle tongue which is configured to spread out the fastening needle head, since it is not obligatory for the fastening needle tongue to be rotatable about the longitudinal axis of the fastening needle system.

According to a further embodiment of the invention, the fastening needle device comprises a resilient force transmission element for transmitting a clamping force to the component, the force transmission element being attached to the base body in such a way that when the components are clamped between the base body and the fastening needle head the force transmission element is arranged between the base body and the component, in such a way that the clamping force can be transmitted from the base body to the force transmission element and from the force transmission element to the components.

In other words, the resilient force transmission element may be understood to be a type of buffer element which can be arranged between the component and the base body when the component is clamped between the fastening needle head and the base body. Further, the resilient force transmission element may be resilient in the direction of the clamping force to be exerted. This means that when the component or components are clamped the resilient force transmission element can receive the clamping force if the clamping force exceeds a particular maximum force to be exerted on the components. For example, the resilient force transmission element may be a spring element, a gum or rubber element, or an element made of one or more resilient materials.

The clamping force may vary between 800 N and 2000 N, depending on the spring element or plate spring size and plate spring type.

In this way, the clamped components can be protected by the force transmission element. It is thus possible to prevent the components from being damaged when the components are clamped using the fastening device.

According to a further embodiment of the invention, the transmission of the clamping force to the component through the force transmission element limits the maximum clamping force transmissible to the component.

In this context, the maximum clamping force transmissible to the component can be configured by targeted selection of a force transmission element having a particular property or material property. In this way, the user of the fastening device can be prevented from exerting an excessive clamping force on the components, potentially damaging the components.

According to a further embodiment of the invention, the resilient force transmission element is a spring element.

For example, the spring element may be a spiral spring or a plate spring package. In this way, the maximum clamping force can be defined by selecting a spring element having a particular spring constant. Moreover, the maximum clamping force of the fastening device can also be changed by replacing the spring element. For example, depending on the component, different fastening devices having different spring elements may be provided, in such a way that a particular clamping force is not exceeded for each component. Thus for example a fastening device having a reduced clamping force may be provided for clamping components comprising carbon fibre composite materials.

According to a further embodiment of the invention, the fastening device comprises a pressure sleeve for exerting the clamping force on the components. Further, the force transmission element is arranged in the internal space of the base body and the pressure sleeve is arranged on the force transmission element in such a way that when the components are clamped the clamping force can be transmitted from the force transmission element to the pressure sleeve and from the pressure sleeve to the components.

In other words, the pressure sleeve may be arranged between the force transmission element and the component. As a result of the force transmission element being arranged in the internal space of the base body, the force transmission element can be arranged in such a way that it is not directly accessible from the outside. In this way, the fastening device may be configured such that the maximum clamping force transmissible to the component cannot be manipulated by a user of the fastening device. In this way, the safety of the fastening device in relation to possible material damage can be increased, since the maximum exertable clamping force cannot be circumvented.

A further aspect of the invention relates to a clamping system which comprises a fastening device as described in the context of the present invention and fastening pliers which comprise two spreading jaws for transmitting the clamping force to the base body and the fastening needle system, leading to a displacement of the fastening needle system relative to the base body. Further, at least one spreading jaw of the fastening pliers is adapted to the cross section of the fastening needle system in such a way that the fastening pliers exert a torque on the fastening needle system as a result of rotation about the longitudinal axis of the fastening needle system.

The fastening pliers may for example be spreading pliers which are configured in such a way that when the plier levers are pressed together the spreading jaws of the fastening pliers are spread apart. This may for example be achieved in such a way that the pliers have a construction having a plurality of articulations.

The adaptation of at least one spreading jaw of the spreading pliers to the cross section of the fastening needle system may be configured in such a way that at least one spreading jaw of the fastening pliers comprises a recess which is adapted to the cross section of the fastening needle system. For example, the cross section of the fastening needle system may be circular and have a flattened face. This flattened face of the fastening needle system may correspond to a region of the recess of the spreading jaws of the fastening pliers. This can prevent the fastening needle system from being able to rotate relative to the spreading jaws of the fastening pliers. Further, it is also possible for both spreading jaws of the fastening pliers to be adapted to the cross section of the fastening needle system.

In this way a simple, relatively cost-effective tool may be provided which can simultaneously be used for clamping the fastening device and for arresting the fastening device in one work sequence.

A further aspect of the invention relates to a method for clamping two components to be connected, using a fastening system as described in the context of the present invention. The method comprises the steps of inserting the fastening needle into a hole in the components to be connected, applying the spreading jaws to the base body and fastening needle system of the fastening device, and spreading the spreading jaws of the fastening pliers to clamp the components to be connected.

Moreover, the method may comprise the step of rotating the pliers about the longitudinal axis of the fastening needle system to arrest the fastening needle system.

Thus, by the described method, a component can be clamped in a simple manner using the fastening device described in the context of the present invention.

The described embodiments relate equally to a fastening device, to a fastening system and to a method, even though individual embodiments are described exclusively in relation to a fastening device, a fastening system or a method. Synergistic effects may arise from different combinations of the embodiments, even if they are not described in the following.

Further features, advantages and possible applications of the invention may be derived from the following description of the embodiments and drawings. In this context, all of the features which are described and/or shown in the drawings, in isolation or in any reasonable combination, form the subject matter of the invention, irrespective of how they are compiled in the claims or the dependencies thereof.

In the following, embodiments of the present invention are described with reference to the drawings.

### BRIEF DESCRIPTION OF THE DRAWINGS

FIG. 1 shows a fastening screw.

FIG. 2 shows a fastening device in accordance with an embodiment of the invention.

FIG. 3 shows a fastening system in accordance with an embodiment of the invention.

FIG. 4 is a flow chart for a method in accordance with an embodiment of the invention.

FIG. 5A, FIG. 5B and FIG. 5C each show a tensioning cam in accordance with an embodiment of the invention.

The drawings are schematic and not necessarily to scale. If like reference numerals are given in different drawings in the following description, they denote like or similar elements. However, like or similar elements may also be denoted by different reference numerals.

### DETAILED DESCRIPTION

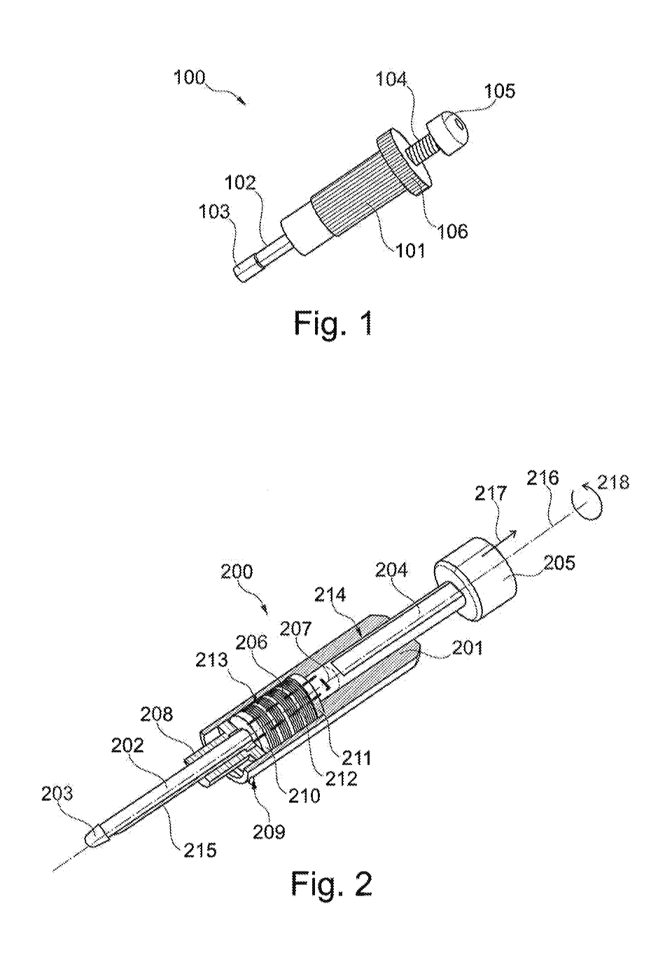

FIG. 1 shows a fastening screw 100. The fastening screw 100 comprises a base body 101, a fastening needle 102 and a threaded rod 104. The fastening needle head 103 is arranged at the front end of the fastening needle 102. At the end of the threaded rod there is a projection 105, which may for example be connected to a power screwdriver in such a way that the threaded rod can be screwed using the power screwdriver. The base body 101 further comprises a knurled nut 106 which facilitates the tightening of the threaded rod 104.

When the threaded rod 104 is tightened, the fastening needle 102 is retracted, the fastening needle head 103 being spread out in the process. In this way, the fastening screw 100 can be guided through a hole in one or more components from one side. Subsequently, the threaded rod 104 can be tightened, causing the fastening needle 102 to retract and the fastening needle head 103 to spread out. In this way, components can be clamped between the fastening needle head 103 and the base body 101.

FIG. 2 shows a fastening device 200 in accordance with an embodiment of the invention.

The fastening device 200 comprises a base body 201 and a fastening needle system 212. An internal space 214, in which the fastening needle system 212 is guided, is arranged in the base body 201. The internal space 214 is configured in such a way that the fastening needle system 212 is displaceable in the direction of the longitudinal axis 216 of the fastening needle system 212.

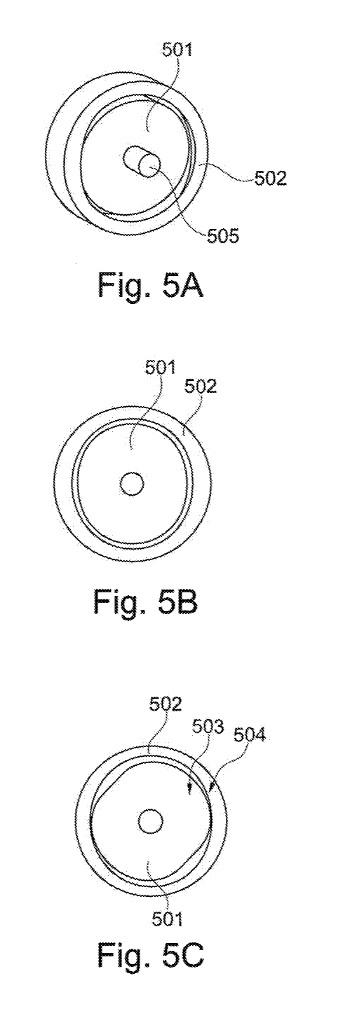

The fastening needle system 212 comprises a fastening needle 202, which has a fastening needle head 203, and a fastening needle shaft 204, which is connected to the fastening needle 202 in such a way that the fastening needle shaft 204 is rotatable with respect to the fastening needle 202. However, the fastening needle shaft 204 cannot be moved relative to the fastening needle 202 in the direction of the longitudinal axis 216 of the fastening needle system 212. This means that in the event of a movement along the longitudinal axis 216 of the fastening needle shaft 204 there is also a movement along the longitudinal axis 216 of the fastening needle 202. A threaded ring 205 is arranged at the upper end of the fastening needle shaft. By screwing the threaded ring 205, the distance between the base body 201 and the threaded ring 205 can be adjusted. For example, the distance between the base body 201 and the threaded ring 205 can be adapted to the size of a pair of spreading pliers. A region of the fastening needle shaft 204 is additionally configured as a cam 207, in such a way that the fastening needle system can be arrested or locked in a particular position. The function of the cam 207 is described in detail in the description of the embodiments shown in FIGS. 5A, 5B and 5C.

The fastening device 200 additionally comprises a resilient force transmission element 206, which in the shown embodiment of the invention is configured as a plate spring package. This force transmission element 206 is arranged in a second internal space 213 of the base body, the fastening needle 202 being guided through in the centre of the force transmission element, as is shown by means of the dashed lines. This means that in the centre of the force transmission element there is an opening and/or a hole through which the fastening needle 202 is guided. Washers 210 and 211 are additionally arranged at the two ends of the force transmission element 206. At the end of the force transmission element 206 facing the fastening needle head 203, there is additionally a pressure sleeve 208. This pressure sleeve 208 is retained in the internal space 213 of the base body by means of a cylindrical pin 209, which is guided through the internal space 213 of the base body 201 laterally with respect to the longitudinal axis 216 of the fastening needle system 212 and perpendicular to the fastening needle system 212. However, there are also other options for holding the pressure sleeve 208 in the internal space 213 of the base body 201. The pressure sleeve 208 additionally comprises a hole through which the fastening needle 202 is guided and is displaceable. The fastening device 200 further comprises a fastening needle tongue 215, which is guided in a groove in the fastening needle 202.

By exerting a tensile force 217 on the fastening needle shaft 204, said tensile force acting in a direction pointing away from the fastening needle 202 and/or the component arranged between the fastening needle head 203 and the pressure sleeve 208, the entire fastening needle system is displaced in the direction of the tensile force 217. This means that as a result of the tensile force 217 being exerted, the fastening needle 202 is retracted relative to the base body 201. In this way, the distance between the pressure sleeve 208 and the fastening needle head 203 is reduced. As a result of the fastening needle 202 being retracted, the fastening needle tongue 215 is guided through the groove of the fastening needle head 203. In this way, the fastening needle head is spread out and the diameter of the fastening needle head 203 is increased. Thus, when the fastening needle 202 is guided through a hole in one or more components and the fastening needle system 212 is retracted, the fastening needle head 203 is spread out, in such a way that it no longer fits through the opening in the component or components. In this way, components can be clamped between the fastening needle head 203 and the pressure sleeve 208. If a tensile force continues to be exerted on the fastening needle system 212 after the component or components have been clamped between the fastening needle head 203 and the pressure sleeve 208, this further tensile force can be received by the resilient force transmission element 206. This means that if a tensile force continues to be exerted on the component or components, this tensile force is transmitted via the pressure sleeve 208 to the resilient force transmission element 206. In this way, the maximum clamping force exerted on the component or components can be limited. Once the component or components have been clamped, the fastening needle system can be arrested or locked in the base body 201 by means of the cam 207 by rotating the fastening needle shaft 204.

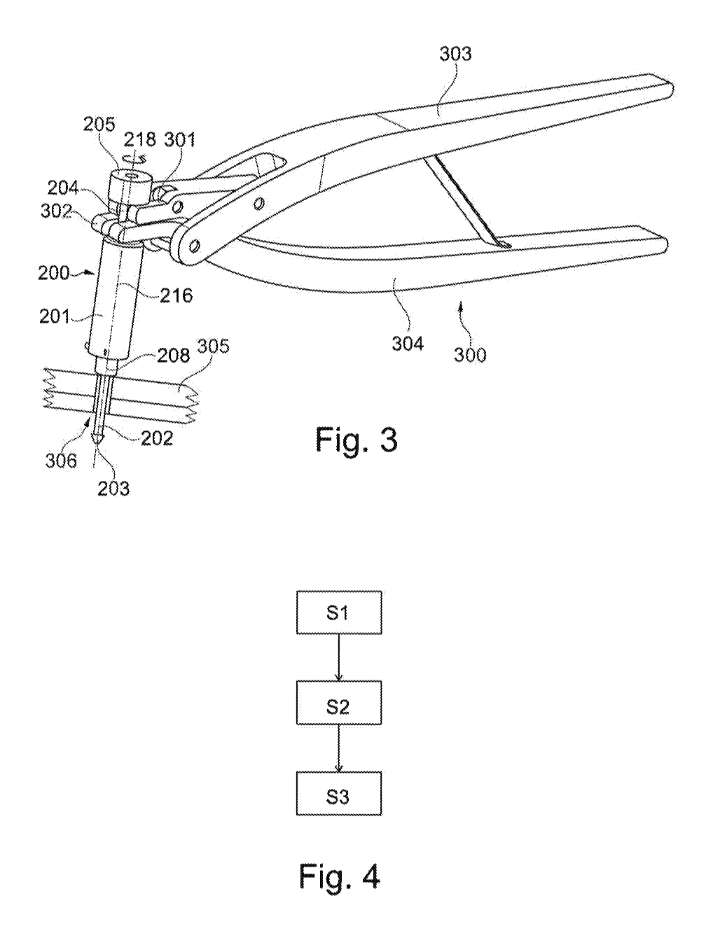

FIG. 3 shows a fastening system in accordance with an embodiment of the invention. The fastening system comprises a fastening device 200, as described in detail for example in the description of FIG. 2, and fastening pliers 300.

The fastening pliers 300 comprise a first spreading jaw 301 and a second spreading jaw 302 and two levers 303 and 304. By pressing the levers 303 and 304 together, the spreading jaws 301 and 302 are pushed apart or spread out as a result of the construction of the fastening pliers. This is made possible for example by the multi-articulated configuration of the fastening pliers 300.

The fastening needle 202 of the fastening needle system 200 is guided through a hole 306 in one or more components 305. By retracting the fastening needle 202, the components 305 can be clamped between the pressure sleeve 208 and the fastening needle head 203 of the fastening device 200. When the fastening needle 202 is retracted, the fastening needle head 203 is spread out, in such a way that the fastening needle head 203 no longer fits through the hole 306 and the components 305 are clamped.

The components 305 can be clamped in a simple manner by means of the fastening pliers 300. The fastening pliers 300 are arranged on the fastening device 200 in such a way that the spreading jaws 301 and 302 are located between the base body 201 and the threaded ring 205 of the fastening device 200. When the levers 303 and 304 are pressed together, the spreading jaws 301 and 302 are pushed apart, increasing the distance between the base body 201 and the threaded ring 205. This in turn results in the fastening needle 202 retracting relative to the base body or to the pressure sleeve 208 and the fastening needle head 203 spreading out. In this way, the components 305 are clamped between the fastening needle head 203 and the pressure sleeve 208. If a tensile force continues to be exerted on the fastening needle system or on the threaded ring after the components 305 are clamped between the fastening needle head 203 and the pressure sleeve 208, the pressure sleeve may also yield upwards by means of the resilient force transmission element or plate spring package arranged in the interior of the base body 201. This prevents a particular maximum force which should not be exceeded when the components 305 are clamped from being exceeded.

After the clamping, the fastening needle system may be arrested or locked in that there is a rotation 218 about the longitudinal axis 216 of the fastening needle system by way of the fastening pliers, for example through 90°. The spreading jaws of the fastening pliers 301 and 302 are adapted to the fastening needle shaft in such a way that when the pliers 300 rotate the fastening needle shaft 204 also rotates. This rotation of the fastening needle shaft in turn results in the cam locking in the base body 201 of the fastening device 200, in such a way that the components 305 remain clamped even after the piers 300 are taken away.

So as to undo the clamping of the components 305 again, a rotation in the opposite direction is exerted on the fastening needle shaft, for example by means of the pliers 300, in such a way that the cam in the base body 201 is released from the arresting again. After the arresting is released, the fastening needle can be displaced forwards again, in such a way that the spreading of the fastening needle head 203 is reversed again. Subsequently, the fastening device can be pulled back out of the hole 306 in the components 305.

FIGS. 5A, 5B and 5C, each show a cam 501 in a base body 502 in accordance with an embodiment of the invention. This cam 501 corresponds for example to the cam 207 of the fastening needle system 212. FIG. 5A shows the cam 501 in perspective, and FIGS. 5B and 5C each illustrate a cross section of the cam 501. The cross section of FIGS. 5B and 5C corresponds for example to a cross section of the fastening device 200 through the region 207 of the fastening needle system 212 perpendicular to the longitudinal direction of the fastening needle system 212.

The cam 501 has for example an oval cross section which corresponds to the cross section of the base body 502. According to this embodiment, the internal space of the base body 502 is configured as a hole having an oval cross section or a slot.

FIG. 5B shows an orientation of the fastening needle system in which the oval cross section of the fastening needle system and the slot of the base body 502 have the same orientation. In this configuration of FIG. 5B, the region of the fastening needle system 501 is not locked to the base body 502. This means that FIG. 5B shows the non-arrested configuration of the fastening needle system. In this configuration, a longitudinal movement of the fastening needle system relative to the base body is thus possible.

FIG. 5C shows the oval region of the fastening needle system 501 and the region of the base body comprising the slot hole 502 in the locked configuration or arrested configuration. In this configuration, the radially extended region 503 of the cam 501 and the more tightly radially touching region 504 of the base body 502 are in contact. In this way, the fastening needle system is arrested or locked to the base body in a friction fit.

The shape shown in FIGS. 5A, 5B and 5C of the cross section of the cam is purely exemplary and should not be treated as limiting. Different possible shapes or cross sections by means of which the fastening needle system can be arrested in a friction fit will be apparent to the person skilled in the art.

FIG. 4 is a flow chart of a method in accordance with an embodiment of the invention. The method comprises the step S1 of inserting the fastening needle into a hole in the components to be connected, the step S2 of applying the spreading jaws of the fastening pliers to the base body and fastening needle system of the fastening device, and the step S3 of spreading the spreading jaws of the fastening pliers. Moreover, the method may comprise the further step of rotating the pliers about the longitudinal axis of the fastening needle system to arrest the fastening needle system.

For completeness, it should be noted that “comprising” does not exclude the possibility of other elements or steps, and “an” or “a” does not exclude the possibility of a plurality. It should further be noted that features or steps which were described in the above with reference to one of the above embodiments may also be used in combination with other features of other above-described embodiments. Reference numerals in the claims should not be treated as limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fastening device for temporarily clamping a component, the fastening device comprising:
a fastening needle system comprising a fastening needle and a fastening needle head; and
a base body comprising an internal space for guiding the fastening needle system;
wherein the fastening needle system is displaceable relative to the base body in the internal space of the base body by applying a tensile force to the fastening needle system in the direction of a longitudinal axis of the fastening needle system; and
wherein the fastening device is configured to clamp the component between the fastening needle head and the base body.

2. The fastening device according to claim 1, wherein the fastening needle system is configured to be arrested in the internal space of the base body by rotating the fastening needle system about the longitudinal axis of the fastening needle system.

3. The fastening device according to claim 2, wherein the fastening needle system comprises a cam for arresting the fastening needle system in the internal space of the base body.

4. The fastening device according to claim 2, wherein the fastening needle system comprises a fastening needle shaft connected to the fastening needle in such a way that the fastening needle shaft is rotatable with respect to the fastening needle when the fastening needle system is arrested.

5. The fastening device according to claim 1, further comprising:
a resilient force transmission element for transmitting a clamping force to the component;
wherein the force transmission element is attached to the base body in such a way that when the components are clamped between the base body and the fastening needle head the force transmission element is arranged between the base body and the component, in such a way that the clamping force can be transmitted from the base body to the force transmission element and from the force transmission element to the components.

6. The fastening device according to claim 5, wherein the transmission of the clamping force to the component through the force transmission element limits the maximum clamping force transmissible to the component.

7. The fastening device according to claim 5, wherein the resilient force transmission element is a spring element.

8. The fastening device according to claim 5, further comprising:
a pressure sleeve for exerting the clamping force on the component;
wherein the force transmission element is arranged in the internal space of the base body; and
wherein the pressure sleeve is arranged on the force transmission element in such a way that when the components are clamped the clamping force can be transmitted from the force transmission element to the pressure sleeve and from the pressure sleeve to the components.

9. A fastening system, comprising:
a fastening device comprising:
a fastening needle system comprising a fastening needle and a fastening needle head;
a base body comprising an internal space for guiding the fastening needle system; and
fastening pliers comprising first and second spreading jaws for transmitting the clamping force to the base body and the fastening needle system, leading to a displacement of the fastening needle system relative to the base body;
wherein the fastening needle system is displaceable relative to the base body in the internal space of the base body by applying a tensile force to the fastening needle system in the direction of a longitudinal axis of the fastening needle system,
wherein the fastening device is configured to clamp the component between the fastening needle head and the base body, and
wherein at least one of the first and second spreading jaws of the fastening pliers is adapted to a cross section of the fastening needle system in such a way that the fastening pliers exert a torque on the fastening needle system as a result of rotation about the longitudinal axis of the fastening needle system.

10. A method for clamping two components to be connected, using a fastening system according to claim 9, the method comprising:
inserting the fastening needle into a hole in the components to be connected;
applying the spreading jaws of the fastening pliers to the base body and to the fastening needle system of the fastening device; and
spreading the spreading jaws of the fastening pliers to clamp the components to be connected.
